(19) United States
(12) Patent Application Publication
(10) Pub. No.: US 2022/0371233 A1
(43) Pub. Date: Nov. 24, 2022

(54) METHOD OF MANUFACTURING MOLDED BODY, THERMO-COMPRESSED MOLDED BODY, AND USE THEREOF

(71) Applicant: The University of Tokyo, Tokyo (JP)

(72) Inventors: Yuya Sakai, Tokyo (JP); Kota Machida, Tokyo (JP)

(73) Assignee: The University of Tokyo, Tokyo (JP)

(21) Appl. No.: 17/747,790

(22) Filed: May 18, 2022

(30) Foreign Application Priority Data
May 24, 2021 (JP) 2021-087111

(51) Int. Cl. B29C 43/00; B29C 43/52; B29B 13/02

(52) U.S. Cl. CPC B29C 43/003; B29C 43/006; B29C 43/52; B29B 13/021; B29K 2105/26

(57) ABSTRACT

According to an embodiment, there is provided a method of manufacturing a molded body from a waste material including at least one of food waste and seaweed, the method comprising: preparing dry powder made from at least the waste material; and forming a molded body by pressurizing the dry powder in a state in which the dry powder is heated to a predetermined temperature.

### RELATED APPLICATIONS

This application is based upon and claims the benefit of priority from Japanese Patent Application No. 2021-087111, filed on May 24, 2021, the entire contents of which are incorporated herein by reference.

### BACKGROUND OF THE INVENTION

### Field of the Invention

Embodiments of the present invention relate to a method of manufacturing a molded body, a thermo-compressed molded body, and use thereof.

### Description of Related Art

For sustainable development goals (SDGs) adopted by UN member countries as a background, there has been increasing interest in effective use of a large amount of discarded food waste. In addition to food loss such as leftover food, a large amount of inedible portions of food are also discarded, and a method for effectively utilizing such food waste has been required. Other examples in which a large amount of waste has been generated and has not sufficiently been utilized include seaweed.

As an example of using such a waste material, Japanese Unexamined Patent Application, First Publication No. 2011-026170 describes a technique of kneading raw materials for ceramics or mineral waste with plant-based materials such as food waste to form a molded body. However, the technique of Japanese Unexamined Patent Application, First Publication No. 2011-026170 is for a ceramic product, and applications thereof are limited.

### SUMMARY OF THE INVENTION

Therefore, an object of the present invention is to provide a method of manufacturing a molded body, a thermo-compressed molded body, and use thereof capable of effectively utilizing waste materials including food waste and seaweed for multiple applications.

The present invention includes the following aspects.

[1] A method of manufacturing a molded body from a waste material including at least one of food waste and seaweed, the method including:

preparing dry powder made from at least the waste material; and

forming a molded body by pressurizing the dry powder in a state in which the dry powder is heated to a predetermined temperature.

[2] The method according to [1], in which the food waste is an inedible portion of food.

[3] The method according to [1] or [2], in which the waste material is a part or the entirety of one or more materials selected from the group consisting of oranges, green soybeans, pumpkins, cabbages, onions, Chinese cabbages, bananas, broccoli, maitake mushrooms, iyokan oranges, coffee beans, sea lettuces, strawberries, crab shells, spinaches, and purple potatoes.

[4] The method according to any one of [1] to [3], in which the waste material includes sugar, and in which the predetermined temperature is a melting point or higher of the sugar in the waste material.

[5] The method according to any one of [1] to [4], in which the predetermined temperature is 50° C. or higher and 200° C. or lower.

[6] The method according to any one of [1] to [5], in which in the forming of the molded body, a pressure applied to the dry powder is 4 MPa or more and 50 MPa or less.

[7] The method according to any one of [1] to [6], in which the preparing of the dry powder includes drying the waste material and crushing the dried waste material to prepare the dry powder.

[8] The method according to [7], in which drying the waste material includes performing freeze drying of the waste material.

[9] The method according to any one of [1] to [8], in which in the forming of the molded body, the dry powder is mixed with a seasoning and thermo-compressed.

[10] The method according to any one of [1] to [8], in which the preparing of the dry powder includes mixing and boiling the waste material with a seasoning.

[11] The method according to any one of [1] to [10], in which in the forming of the molded body, the dry powder is mixed with plastic powder and thermo-compressed.

[12] The method according to any one of [1] to [11], in which the molded body consists of the waste material, or consists of the waste material and an edible material.

[13] A thermo-compressed molded body of a waste material including at least one of food waste and seaweed, in which three-point bending strength is 3 MPa or more.

[14] The thermo-compressed molded body according to [13], in which the thermo-compressed molded body consists of the waste material, or consists of the waste material and an edible material.

[15] A construction material, a construction, furniture, a floor cover, a container, interior goods, a tableware, or an ornament, including: the thermo-compressed molded body according to [13] or [14].

### BRIEF DESCRIPTION OF THE DRAWINGS

FIG. 1 is a photograph of food materials after freeze drying.

FIG. 2 is a photograph of the food materials after crushing.

FIG. 3 is a photograph of obtained molded bodies.

FIG. 4 is a graph showing a result of comparing bending strength of the molded bodies obtained from various raw materials.

FIG. 5 is a graph showing molding temperature dependency of bending strength of molded bodies of pumpkins, maitake mushrooms, sea lettuces, and crab shells.

FIG. 6 is a graph showing molding pressure dependency of bending strength of molded bodies of bananas and iyokan oranges.

### DETAILED DESCRIPTION OF THE INVENTION

Hereinafter, a method of manufacturing a molded body, a thermo-compressed molded body, and use thereof according to embodiments will be described. Note that the following embodiments illustrate only aspects of the present invention, are not intended to limit the present invention, and can be arbitrarily modified within the scope of the technical idea of the present invention.

Molded Body

In an embodiment, a thermo-compressed molded body of a waste material containing at least one of food waste and seaweed is provided. As used herein, “food waste” refers to food that has been disposed of after being served for eating, or food that has not been served for eating, or a product that has been obtained as a secondary product in the process of manufacturing, processing, or cooking food and is not able to be served for eating. As used herein, “thermo-compression molding” means molding a target into a desired shape by applying a pressure thereto while heating it.

The food waste included in a waste material is, for example, an inedible portion of foods. As used herein, “inedible portion” means a part of a product that has been obtained as a secondary product in the process of manufacturing, processing, or cooking of foods and is not able to be served for eating. Examples of the inedible portion include vegetable and fruit peels, seeds, cores, meat and fish bones, scales, and the like, but do not include those that are not essentially food-derived, such as containers and packaging.

Examples of the foods include plant-based foods and animal-based foods. Examples of the plant-based foods include vegetables, fruits, grains, potatoes, mushrooms, and edible seaweed. Examples of vegetables include pumpkins, cabbages, lettuces, onions, carrots, radishes, burdocks, Chinese cabbages, broccoli, cauliflowers, spinaches, Japanese mustard spinaches, bok choy, tomatoes, watermelons, melons, peppers, paprikas, cucumbers, bamboo shoots, and tea leaves. Examples of fruits include oranges, tangerines, iyokan oranges, strawberries, bananas, cassis, apples, persimmons, pears, cherries, pineapples, grapes, blueberries, and peaches. Examples of grains include rice, wheat, corn, common millet, foxtail millet, Japanese millet, green soybeans, soybeans, small beans, peas, and coffee beans. Examples of potatoes include potatoes, sweet potatoes, purple potatoes, taros, long potatoes, and yams. Examples of mushrooms include shiitake mushrooms, maitake mushrooms, enoki mushrooms, shimeji mushrooms, nameko mushrooms, and mushrooms. Examples of edible seaweed include sea lettuces, wakame seaweed, kelp, mekabu seaweed, hijiki seaweed, and seaweed. Examples of animal-based foods include meat, eggs, dairy products, fish, and shellfish. Examples of meat include beef, pork, chicken, venison, horse meat, and the like. Examples of eggs include chicken eggs. Examples of dairy products include cheese, butter, and yogurt. Examples of fish and shellfish include fish, shellfish, shrimps, crabs, octopus, and squid. It is possible to provide various molded bodies with color tones, tastes, and aromas in accordance with materials in accordance with applications by using food materials as materials of the molded bodies.

Examples of inedible portions of foods include peels, seeds, stems, and the like of vegetables, fruits, and potatoes, shells, skins, and the like of grains, stems, fungal beds, hard tips, and the like of mushrooms, bones and the like of meat, shells and the like of eggs, and bones, scales, shells and the like of fish and shellfish (for example, fish skins, shrimp and crab shells, and shells).

Examples of seaweed contained in waste materials include green algae, brown algae, and red algae. Examples of green algae include sea lettuces, green laver, acetabularia, cactus, acetabularia, mill, shiogusa, and bryopsidales. Examples of brown algae include Sargassum thunbergii, kelp, hijiki, rockweed, Sargassum, mozuku, trumpet, wakame seaweed, and Dictyotaceae seaweed. Examples of red algae include Pyropia tenera, Gelidiaceae, Nemalion vermiculare, Corallinoideae, Gigartina tenella, Gracilaria tenera, Rhodymenia intricata, and Igis.

The molded body is formed of powder of one or more kinds of waste materials, for example, and is preferably formed of dry powder of one or more kinds of waste materials. As used herein, “dry powder” means a powder having a water content of 5% by weight or less. The molded body is formed of powder of waste materials having a water content of 5% by weight or less, 4% by weight or less, 3% by weight or less, 2% by weight or less, or 1% by weight or less, for example. Note that the molded body may be formed of two or more kinds of waste materials.

The molded body may include any material other than the waste materials. For example, the molded body can include edible materials in addition to the waste materials. As used herein, edible” means that it can be served as a food for human or non-human animals. Examples of the edible materials include plant-based foods, animal-based foods, seasonings, edible clays, edible inks, and edible plastics. Examples of the seasonings include sugar, salt, vinegar, soy sauce, miso, pepper, chili pepper, sauce, ketchup, mayonnaise, consomme powder, soup stock powder, curry powder, and edible oil. It is possible to adjust the taste of the molded body and to provide a molded body that is more suitable for eating by adding seasonings as constituent materials of the molded body. Also, it is possible to provide an edible molded body with improved durability and density by adding an edible clay as a constituent material of the molded body. The molded body preferably consists of the waste material, or consists of the waste material and the edible material. In this case, the molded body is edible as a whole and can be served for eating.

The molded body may include an inedible material. Examples of the inedible material include a plastic material, a metal material, a ceramic material, a textile material, wood, wood chips, grass, paper, a cloth, glass, sand, soil, clay, gravel, stone, cement, concrete, paints, and an adhesive. Examples of the plastic material include polyethylene, polypropylene, polystyrene, polyethylene terephthalate, polycarbonate, and polyamide. For example, it is possible to provide a molded body with improved waterproofness by adding the plastic material or the like as a constituent material of the molded body. In addition, it is possible to add arbitrary materials in accordance with properties required for the molded body.

The content of the food waste and/or the seaweed in the molded body is, for example, 50% by weight or more, 55% by weight or more, 60% by weight or more, 65% by weight or more, 70% by weight or more, 75% by weight or more, 80% by weight or more, 85% by weight or more, 90% by weight or more, or 95% by weight or more. The content of components other than the food waste and/or the seaweed in the molded body is, for example, 50% by weight or less, 40% by weight or less, 30% by weight or less, 25% by weight or less, 20% by weight or less, 15% by weight or less, 10% by weight or less, or 5% by weight or less. The content of the seasoning and/or the edible clay in the molded body is, for example, 50% by weight or less, 40% by weight or less, 30% by weight or less, 25% by weight or less, 20% by weight or less, 15% by weight or less, 10% by weight or less, or 5% by weight or less. The content of the plastic powder in the molded body is, for example, 50% by weight or less, 40% by weight or less, 30% by weight or less, 25% by weight or less, 20% by weight or less, 15% by weight or less, 10% by weight or less, or 5% by weight or less.

The molded body can be used for arbitrary applications and can be used, for example, as a material of a construction material, a construction, furniture, a floor cover, a container, interior goods, a tableware, or an ornament (hereinafter, also collectively referred to as “a construction material, etc.”). It is possible to form an edible construction material, etc. by configuring the molded body using only edible materials. Such an edible construction material, etc. can be used as an emergency ration at the time of emergency, for example. Also, the molded body may be used as a fertilizer after being used as a construction material, etc.

The molded body is molded to have arbitrary size, shape, structure, density, and weight in accordance with its application. Additionally, the molded body is molded to have various properties such as strength, rigidity, hardness, waterproofness, heat resistance, and the like in accordance with its application. The molded body has properties suitable for an application of construction, for example. The molded body preferably has three-point bending strength of 3 MPa or more, which is a reference of bending strength of sidewalk pavement of an interlocking block defined by JIS A 5371:2016. The molded body more preferably has three-point bending strength of 5 MPa or more, which is a reference of bending strength of roadway pavement of an interlocking block defined by JIS A 5371:2016. The molded body preferably has compressive strength of 17 MPa or more, which is a reference of compressive strength of sidewalk pavement of an interlocking block defined by JIS A 5371:2016. The molded body more preferably has compressive strength of 32 MPa or more, which is a reference of compressive strength of roadway pavement of an interlocking block defined by JIS A 5371:2016.

Method of Manufacturing Molded Body

In an embodiment, there is provided a method of manufacturing a molded body from a waste material including at least one of food waste and seaweed, the method including the steps of: preparing dry powder made from at least a waste material; and forming a molded body by pressurizing the dry powder in a state in which the dry powder is heated to a predetermined temperature.

In an embodiment, the step of preparing the dry powder includes a drying step of drying the waste material and a crushing step of crushing the dried waste material to prepare the dry powder.

Drying Step

In the drying step, the waste material is dried by an arbitrary means. For example, the drying step may include a process of drying the waste material under a reduced pressure, may include a process of freeze-drying the waste material, may include a process of drying the waste material by heating it by a heating device such as an oven or a warm wind device, or may use these processes in combination. As used herein, “freeze-drying” means a drying method in which a material is placed under reduced pressure to promote evaporation of water. As used herein, “freeze-drying” means a drying method in which the moisture in a material is frozen and the moisture is sublimated in a vacuum (decompression) state (also referred to as freeze-drying). Note that efficient drying can be achieved by finely chopping, crushing, or smashing the waste material before the drying step.

Crushing Step

In the crushing step, the dried waste material is further finely crushed (into a powder form, for example) by an arbitrary means. For example, the crushing step may include a process of crushing the material by a general blender, a mixer, or the like for cooking or may include a process of crushing the material by an arbitrary crusher such as a disc mill, a ball mill, or a jet mill.

In one embodiment, the step of forming the molded body includes a thermo-compressing step of pressurizing the material in a heated state. The step of forming the molded body may further include a mixing step of mixing the dry powder with other materials before the thermo-compressing step.

Mixing Step

In the mixing step, the dry powder of the waste material crushed in the crushing step is mixed with other materials by an arbitrary means. For example, the mixing step may include a process of manually mixing each material using a cooking tool such as chopsticks or a spoon or a process of mixing each material by a blender, a mixer, or the like.

Examples of other materials mixed with the waste material include various edible materials and inedible materials as described above. For example, the dry powder may be mixed with a seasoning and thermo-compressed, or the dry powder may be mixed with plastic powder and thermo-compressed, in the step of forming the molded body.

Note that the timing at which the mixing with other materials is not limited to the above example. For example, the mixing step may be executed before the drying step, may be executed before the crushing step, or may be incorporated into the crushing step. For example, the step of preparing the dry powder may further include a step of mixing and boiling the waste material with the seasoning before the drying step.

Thermo-Compressing Step

In the thermo-compressing step of forming the molded body by thermo-compressing the dry powder, the crushed material is pressurized and molded in a state in which the material is heated. In the thermo-compressing step, a predetermined molding pressure is applied to the material for a predetermined molding time at a predetermined molding temperature, for example.

The molding temperature can be appropriately determined in accordance with applications. The molding temperature is, for example, 40° C. or higher, 45° C. or higher, 50° C. or higher, 55° C. or higher, 60° C. or higher, 65° C. or higher, 70° C. or higher, 75° C. or higher, 80° C. or higher, 85° C. or higher, 90° C. or higher, 95° C. or higher, or 100° C. or higher. The molding temperature is, for example, 300° C. or lower, 250° C. or lower, 200° C. or lower, 195° C. or lower, 190° C. or lower, 185° C. or lower, 180° C. or lower, 175° C. or lower, 170° C. or lower, 165° C. or lower, or 160° C. or lower. The molding temperature is, for example, 50° C. or higher and 200° C. or lower.

In a case in which the waste material contains sugar, the molding temperature is preferably equal to or greater than the melting point of the sugar in the waste material. Also, the molding temperature is preferably less than the combustion temperature or the thermal decomposition temperature of the sugar. Although the present invention is not intended to be limited by theory, a mechanism in which the sugar in the material is melt, functions as an adhesive, maintains the shape of the molded body, and enhances the strength by performing the thermo-compression molding at a molding temperature that is equal to or greater than the melting point of the sugar contained in the waste material as will be described below with reference to experimental examples.

The molding pressure applied to the dry powder can be appropriately determined in accordance with applications. The molding pressure is, for example, 1 MPa or more, 2 MPa or more, 3 MPa or more, 4 MPa or more, 5 MPa or more, 10 MPa or more, 15 MPa or more, 20 MPa or more, 25 MPa or more, or 30 MPa or more. The molding pressure is, for example, 100 MPa or less, 90 MPa or less, 80 MPa or less, 70 MPa or less, 60 MPa or less, or 50 MPa or less. The molding pressure is, for example, 4 MPa or more and 50 MPa or less.

The molding time can be appropriately determined in accordance with applications. The molding time is, for example, 10 seconds or more, 20 seconds or more, 30 seconds or more, 40 seconds or more, 50 seconds or more, 1 minute or more, 2 minutes or more, 3 minutes or more, 4 minutes or more, 5 minutes or more, or 10 minutes or more. The molding time is, for example, 1 hour or less, 50 minutes or less, 40 minutes or less, 30 minutes or less, 25 minutes or less, or 20 minutes or less.

In the step of forming the molded body, the dry powder may be mixed with water and thermo-compressed. For example, water may be added to the dry powder in the mixing step, or water may be added to the dry powder immediately before performing the thermo-compression. Hereinafter, the ratio of the weight of water with respect to the total weight of the dry powder and the water in the case in which the water is added to the dry powder as a raw material before the thermo-compression will be referred to as “water content”. The water content of 0% means that no water is added thereto. The water content is, for example, 0% or more, 1% or more, 2% or more, 3% or more, 4% or more, or 5% or more. The water content is, for example, 20% or less, 15% or less, or 10% or less.

### Examples

Hereinafter, examples according to the present invention will be described with reference to FIGS. 1 to 6. These examples are not intended to limit the present invention.

1. Molding Using Only Food Materials

First, whether or not it was possible to achieve molding using only dry powder of food materials was studied. Molding was attempted with a molding temperature, a molding pressure, a molding time, and water content changed under basic conditions of a molding temperature of 100° C., a molding pressure of 50 MPa, a molding time of 10 minutes, and water content (the amount of water added to the materials of 0%. Experimental conditions of each experimental example were summarized in Table 1, which will be described later.

Food materials used were oranges (Experimental Example 1), green soybeans (Experimental Example 2), pumpkins (Experimental Examples 3 to 11), cabbages (Experimental Examples 12 to 16), onions (Experimental Example 17), Chinese cabbages (Experimental Examples 18 and 19), bananas (Experimental Examples 20 to 27), broccoli (Experimental Examples 28 to 30), maitake mushrooms (Experimental Examples 31 to 34), iyokan oranges (Experimental Examples 35 to 47), coffee beans (Experimental Examples 48 to 50), sea lettuces (Experimental Examples 51 to 59), strawberries (Experimental Example 60), crab shells (Experimental Examples 61 to 65), spinaches (Experimental Example 66), purple potatoes (Experimental Example 67), and a mixture of pumpkins and Chinese cabbages (Experimental Example 68). In Experimental Examples 1 to 50 and 68, thermo-compression molding of dry powder obtained from inedible portions of commercially available food materials was carried out. In Experimental Examples 51 to 67, commercially available dry powder was used to carry out the thermo-compression molding. The inedible portions of each food material used were orange peels, green soybean shells, pumpkin peels, entire cabbages, onion peels, entire Chinese cabbages, banana peels, broccoli stems, maitake mushroom stems and fungal beds, iyokan orange peels, and coffee bean shells.

### Experimental Example 1

An edible portion and an inedible portion of commercially available oranges were separated, the edible portion was consumed for eating, and the remaining inedible portion was used as a raw material. The inedible portion was cut into small pieces as much as possible and was then dried by a vegetable dryer (AFD-550 dry food maker manufactured by Apix International Co., Ltd.) for about 10 to 30 hours. Next, the material was freeze-dried using a vacuum dryer (FDU-2200 manufactured by Tokyo Rika Kikai Co., Ltd.) to remove water in the inedible portion. After confirming that the change in mass due to the withdrawal of water had stopped, drying was ended. A photograph of the food materials after freeze drying is shown in FIG. 1.

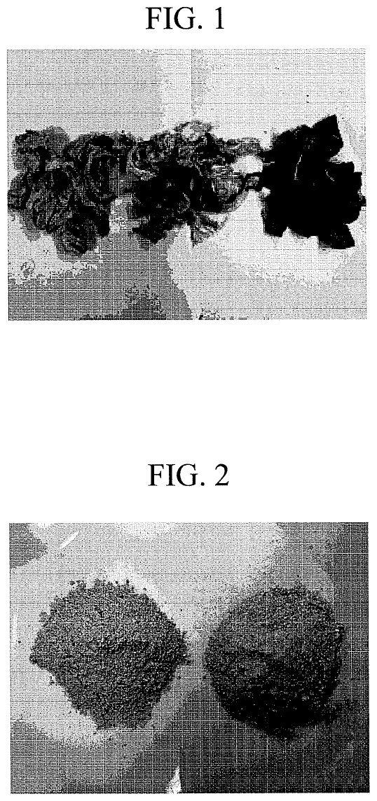

The inedible portion after the drying was crushed by a disc mill. The dry powder after the crushing was sealed in a sealable bag, such that moisture in the air was not absorbed during the storage. Note that as a machine used for performing the crushing in each of the following experimental examples, a disc mill or a household blender was used depending on how hard the inedible portions were. A photograph of the food materials after crushing is shown in FIG. 2.

Then, the dry powder was thermo-compressed using a thermo-compression molding machine (H300-15 manufactured by AS ONE Corporation). After a mold frame for molding was placed on a hot plate and was heated to 100° C., the dry powder was put into the mold frame. Here, no water was added to the dry powder (water content of 0%). A lever of a manual hydraulic pump was operated to apply a pressure of 50 MPa to the dry powder. Since a pressure decrease due to escaping of air and the like from the dry powder occurs during the pressurization, the pressure of 50 MPa was maintained by appropriately adjusting the pressure. After the application of the pressure for 10 minutes, the pressure was released, and the thermo-compressed dry powder was released from the mold, thereby obtaining a molded body made from oranges. A photograph of the thus obtained molded bodies is shown in FIG. 3.

### Experimental Example 2

A molded body made from green soybeans was obtained in a manner similar to that in Experimental Example 1, except that commercially available green soybeans were used instead of oranges and water was added to the dry powder such that the water content before thermo-compression became 10%.

### Experimental Example 3

Formation of a molded body made from pumpkins was attempted in a manner similar to that in Experimental Example 1, except that commercially available pumpkins were used instead of oranges and the molding temperature was set to a room temperature (no heating). However, the molded body obtained under these conditions was very brittle and easily collapsed.

### Experimental Example 4

Formation of a molded body made from pumpkins was attempted in a manner similar to that in Experimental Example 1, except that commercially available pumpkins were used instead of oranges and the molding temperature was set to 60° C. However, the molded body obtained under these conditions was very brittle and easily collapsed.

### Experimental Example 5

A molded body made from pumpkins was obtained in a manner similar to that in Experimental Example 1, except that commercially available pumpkins were used instead of oranges and the molding temperature was set to 80° C.

### Experimental Example 6

A molded body made from pumpkins was obtained in a manner similar to that in Experimental Example 1, except that commercially available pumpkins were used instead of oranges.

### Experimental Example 7

A molded body made from pumpkins was obtained in a manner similar to that in Experimental Example 1, except that commercially available pumpkins were used instead of oranges and the molding temperature was set to 120° C.

### Experimental Example 8

A molded body made from pumpkins was obtained in a manner similar to that in Experimental Example 1, except that commercially available pumpkins were used instead of oranges and the molding temperature was set to 140° C.

### Experimental Example 9

A molded body made from pumpkins was obtained in a manner similar to that in Experimental Example 1, except that commercially available pumpkins were used instead of oranges and the molding temperature was set to 160° C.

### Experimental Example 10

A molded body made from pumpkins was obtained in a manner similar to that in Experimental Example 1, except that commercially available pumpkins were used instead of oranges, the molding temperature was set to 180° C., and the molding pressure was set to 6 MPa.

### Experimental Example 11

A molded body made from pumpkins was obtained in a manner similar to that in Experimental Example 1, except that commercially available pumpkins were used instead of oranges and the molding temperature was set to 180° C.

### Experimental Example 12

A molded body made from cabbages was obtained in a manner similar to that in Experimental Example 1, except that commercially available cabbages were used instead of oranges and the molding temperature was set to 60° C.

### Experimental Example 13

A molded body made from cabbages was obtained in a manner similar to that in Experimental Example 1, except that commercially available cabbages were used instead of oranges and the molding temperature was set to 80° C.

### Experimental Example 14

Formation of a molded body made from cabbages was attempted in a manner similar to that in Experimental Example 1, except that commercially available cabbages were used instead of oranges. However, the powder was melted and flowed out of the clearance of the mold frame, and the molding was failed, under these conditions.

### Experimental Example 15

Formation of a molded body made from cabbages was attempted in a manner similar to that in Experimental Example 1, except that commercially available cabbages were used instead of oranges and water was added to the dry powder such that the water content before thermo-compression became 5%. However, the powder was melted and flowed out of the clearance of the mold frame, and the molding was failed, under these conditions.

### Experimental Example 16

Formation of a molded body made from cabbages was attempted in a manner similar to that in Experimental Example 1, except that commercially available cabbages were used instead of oranges and water was added to the dry powder such that the water content before thermo-compression became 10%. However, the powder was melted and flowed out of the clearance of the mold frame, and the molding was failed, under these conditions.

### Experimental Example 17

A molded body made from onions was obtained in a manner similar to that in Experimental Example 1, except that commercially available onions were used instead of oranges.

### Experimental Example 18

A molded body made from Chinese cabbages was obtained in a manner similar to that in Experimental Example 1, except that commercially available Chinese cabbages were used instead of oranges and the molding temperature was set to 80° C.

### Experimental Example 19

A molded body made from Chinese cabbages was obtained in a manner similar to that in Experimental Example 1, except that commercially available Chinese cabbages were used instead of oranges.

### Experimental Example 20

A molded body made from bananas was obtained in a manner similar to that in Experimental Example 1, except that commercially available bananas were used instead of oranges, the molding temperature was set to 80° C., and the molding pressure was set to 4 MPa.

### Experimental Example 21

A molded body made from bananas was obtained in a manner similar to that in Experimental Example 1, except that commercially available bananas were used instead of oranges, the molding temperature was set to 80° C., and the molding pressure was set to 10 MPa.

### Experimental Example 22

A molded body made from bananas was obtained in a manner similar to that in Experimental Example 1, except that commercially available bananas were used instead of oranges, the molding temperature was set to 80° C., and the molding pressure was set to 20 MPa.

### Experimental Example 23

A molded body made from bananas was obtained in a manner similar to that in Experimental Example 1, except that commercially available bananas were used instead of oranges, the molding temperature was set to 80° C., and the molding pressure was set to 30 MPa.

### Experimental Example 24

A molded body made from bananas was obtained in a manner similar to that in Experimental Example 1, except that commercially available bananas were used instead of oranges, the molding temperature was set to 80° C., and the molding pressure was set to 40 MPa.

### Experimental Example 25

A molded body made from bananas was obtained in a manner similar to that in Experimental Example 1, except that commercially available bananas were used instead of oranges and the molding temperature was set to 80° C.

### Experimental Example 26

A molded body made from bananas was obtained in a manner similar to that in Experimental Example 1, except that commercially available bananas were used instead of oranges.

### Experimental Example 27

Formation of a molded body made from bananas was attempted in a manner similar to that in Experimental Example 1, except that commercially available bananas were used instead of oranges and the molding temperature was set to 120° C. However, the powder was melted and flowed out of the clearance of the mold frame, and the molding was failed, under these conditions.

### Experimental Example 28

A molded body made from broccoli was obtained in a manner similar to that in Experimental Example 1, except that commercially available broccoli was used instead of oranges and the molding temperature was set to 60° C.

### Experimental Example 29

A molded body made from broccoli was obtained in a manner similar to that in Experimental Example 1, except that commercially available broccoli was used instead of oranges and the molding temperature was set to 80° C.

### Experimental Example 30

Formation of a molded body made from broccoli was attempted in a manner similar to that in Experimental Example 1, except that commercially available broccoli was used instead of oranges. However, the powder was melted and flowed out of the clearance of the mold frame, and the molding was failed, under these conditions.

### Experimental Example 31

Formation of a molded body made from maitake mushrooms was attempted in a manner similar to that in Experimental Example 1, except that commercially available maitake mushrooms were used instead of oranges and the molding temperature was set to 60° C. However, the molded body obtained under these conditions was very brittle and easily collapsed.

### Experimental Example 32

A molded body made from maitake mushrooms was obtained in a manner similar to that in Experimental Example 1, except that commercially available maitake mushrooms were used instead of oranges and the molding temperature was set to 80° C.

### Experimental Example 33

A molded body made from maitake mushrooms was obtained in a manner similar to that in Experimental Example 1, except that commercially available maitake mushrooms were used instead of oranges.

### Experimental Example 34

A molded body made from maitake mushrooms was obtained in a manner similar to that in Experimental Example 1, except that commercially available maitake mushrooms were used instead of oranges and the molding temperature was set to 120° C.

### Experimental Example 35

A molded body made from iyokan oranges was obtained in a manner similar to that in Experimental Example 1, except that commercially available iyokan oranges were used instead of oranges.

### Experimental Example 36

A molded body made from iyokan oranges was obtained in a manner similar to that in Experimental Example 1, except that commercially available iyokan oranges were used instead of oranges, the molding temperature was set to 60° C., and the molding pressure was set to 4 MPa.

### Experimental Example 37

A molded body made from iyokan oranges was obtained in a manner similar to that in Experimental Example 1, except that commercially available iyokan oranges were used instead of oranges, the molding temperature was set to 60° C., and the molding pressure was set to 10 MPa.

### Experimental Example 38

A molded body made from iyokan oranges was obtained in a manner similar to that in Experimental Example 1, except that commercially available iyokan oranges were used instead of oranges, the molding temperature was set to 60° C., and the molding pressure was set to 20 MPa.

### Experimental Example 39

A molded body made from iyokan oranges was obtained in a manner similar to that in Experimental Example 1, except that commercially available iyokan oranges were used instead of oranges, the molding temperature was set to 60° C., and the molding pressure was set to 30 MPa.

### Experimental Example 40

A molded body made from iyokan oranges was obtained in a manner similar to that in Experimental Example 1, except that commercially available iyokan oranges were used instead of oranges, the molding temperature was set to 60° C., and the molding pressure was set to 40 MPa.

### Experimental Example 41

A molded body made from iyokan oranges was obtained in a manner similar to that in Experimental Example 1, except that commercially available iyokan oranges were used instead of oranges and the molding temperature was set to 60° C.

### Experimental Example 42

A molded body made from iyokan oranges was obtained in a manner similar to that in Experimental Example 1, except that commercially available iyokan oranges were used instead of oranges, the molding temperature was set to 60° C., the molding pressure was set to 20 MPa, and the molding time was set to 5 minutes.

### Experimental Example 43

A molded body made from iyokan oranges was obtained in a manner similar to that in Experimental Example 1, except that commercially available iyokan oranges were used instead of oranges, the molding temperature was set to 60° C., the molding pressure was set to 20 MPa, and the molding time was set to 15 minutes.

### Experimental Example 44

A molded body made from iyokan oranges was obtained in a manner similar to that in Experimental Example 1, except that commercially available iyokan oranges were used instead of oranges, the molding temperature was set to 60° C., the molding pressure was set to 20 MPa, and the molding time was set to 20 minutes.

### Experimental Example 45

A molded body made from iyokan oranges was obtained in a manner similar to that in Experimental Example 1, except that commercially available iyokan oranges were used instead of oranges, the molding temperature was set to 60° C., the molding pressure was set to 20 MPa, and the molding time was set to 25 minutes.

### Experimental Example 46

A molded body made from iyokan oranges was obtained in a manner similar to that in Experimental Example 1, except that commercially available iyokan oranges were used instead of oranges, the molding temperature was set to 60° C., the molding pressure was set to 20 MPa, and the molding time was set to 30 minutes.

### Experimental Example 47

A molded body made from iyokan oranges was obtained in a manner similar to that in Experimental Example 1, except that commercially available iyokan oranges were used instead of oranges, the molding temperature was set to 60° C., the molding pressure was set to 20 MPa, and water was added to the dry powder such that the water content before thermo-compression became 5%.

### Experimental Example 48

A molded body made from coffee beans was obtained in a manner similar to that in Experimental Example 1, except that commercially available coffee beans were used instead of oranges and the molding temperature was set to 180° C.

### Experimental Example 49

A molded body made from coffee beans was obtained in a manner similar to that in Experimental Example 1, except that commercially available coffee beans were used instead of oranges, the molding temperature was set to 180° C., and the water content was set to 5%.

### Experimental Example 50

A molded body made from coffee beans was obtained in a manner similar to that in Experimental Example 1, except that commercially available coffee beans were used instead of oranges, the molding temperature was set to 200° C., and the water content was set to 5%.

### Experimental Example 51

Commercially available dry powder of sea lettuces (rich-flavor sea lettuce powder for domestic industries: 500 g, Asahishokuhin Corporation) was prepared, and the dry powder was thermo-compressed using a thermo-compression molding machine under conditions of a molding temperature of 100° C., a molding pressure of 50 MPa, a molding time of 10 minutes, and water content of 0% in a manner similar to that in Experimental Example 1. However, the molded body obtained under these conditions was very brittle and easily collapsed.

### Experimental Example 52

Formation of a molded body made from dry powder of sea lettuce was attempted in a manner similar to that in Experimental Example 51, except that the molding temperature was set to a room temperature (with no heating). However, the molded body obtained under these conditions was very brittle and easily collapsed.

### Experimental Example 53

Formation of a molded body made from dry powder of sea lettuce was attempted in a manner similar to that in Experimental Example 51, except that the molding temperature was set to 60° C. However, the molded body obtained under these conditions was very brittle and easily collapsed.

### Experimental Example 54

Formation of a molded body made from dry powder of sea lettuce was attempted in a manner similar to that in Experimental Example 51, except that the molding temperature was set to 80° C. However, the molded body obtained under these conditions was very brittle and easily collapsed.

### Experimental Example 55

A molded body made from dry powder of sea lettuce was obtained in a manner similar to that in Experimental Example 51, except that the molding temperature was set to 120° C.

### Experimental Example 56

A molded body made from dry powder of sea lettuce was obtained in a manner similar to that in Experimental Example 51, except that the molding temperature was set to 140° C.

### Experimental Example 57

A molded body made from dry powder of sea lettuce was obtained in a manner similar to that in Experimental Example 51, except that the molding temperature was set to 160° C.

### Experimental Example 58

A molded body made from dry powder of sea lettuce was obtained in a manner similar to that in Experimental Example 51, except that the molding temperature was set to 180° C. and the molding pressure was set to 6 MPa.

### Experimental Example 59

A molded body made from dry powder of sea lettuce was obtained in a manner similar to that in Experimental Example 51, except that the molding temperature was set to 180° C.

### Experimental Example 60

A molded body made from dry powder of strawberries was obtained in a manner similar to that in Experimental Example 51, except that commercially available dry powder of strawberries (cotta freeze dry strawberry powder manufactured by cotta Co., Ltd.) was used instead of dry powder of sea lettuce.

### Experimental Example 61

A molded body made from dry powder of crab shells was obtained in a manner similar to that in Experimental Example 51, except that commercially available dry crab shells for a fertilizer (domestically produced crab shell powder: 1 kg, Tamagoya) was used instead of dry powder of sea lettuce and the molding temperature was set to 60° C.

### Experimental Example 62

A molded body made from dry powder of crab shells was obtained in a manner similar to that in Experimental Example 61, except that the molding temperature was set to 80° C.

### Experimental Example 63

A molded body made from dry powder of crab shells was obtained in a manner similar to that in Experimental Example 61, except that the molding temperature was set to 100° C.

### Experimental Example 64

A molded body made from dry powder of crab shells was obtained in a manner similar to that in Experimental Example 61, except that the molding temperature was set to 120° C.

### Experimental Example 65

Formation of a molded body made from dry powder of crab shells was attempted in a manner similar to that in Experimental Example 61, except that the molding temperature was set to 140° C. However, the powder was melted and flowed out of the clearance of the mold frame, and the molding was failed, under these conditions.

### Experimental Example 66

A molded body made from dry powder of spinaches was obtained in a manner similar to that in Experimental Example 51, except that commercially available dry powder of spinaches (spinach powder manufactured by Mikasa Industry Co., Ltd.) was used instead of dry powder of sea lettuce.

### Experimental Example 67

A molded body made from dry powder of purple potatoes was obtained in a manner similar to that in Experimental Example 51, except that commercially available dry powder of purple potatoes (purple potato powder manufactured by Mikasa Industry Co., Ltd.) was used instead of dry powder of sea lettuce.

### Experimental Example 68

A molded body made from pumpkins and Chinese cabbages was obtained in a manner similar to that in Experimental Example 1, except that commercially available pumpkins and Chinese cabbages were used instead of oranges and thermo-compression molding of dry powder mixed to achieve a weight ratio of 3:1 between an inedible portion of pumpkins and an inedible portion of Chinese cabbages was carried out in order to study whether or not it was possible to achieve molding by mixing the plurality of food materials.

As described above, it was confirmed that molded bodies were able to be obtained from any of at least oranges, green soybeans, pumpkins, cabbages, onions, Chinese cabbages, bananas, broccoli, maitake mushrooms, iyokan oranges, coffee beans, sea lettuce, strawberries, crab shells, spinaches, and purple potatoes by adjusting molding conditions. Additionally, it was confirmed that molded bodies were able to be obtained even in a case in which a plurality of food materials were mixed as in Experimental Example 68. However, regarding some food materials, the molded bodies easily collapsed at excessively low molding temperatures, and powder was melted and flowed out of the clearance of the mold frame at excessively high molding temperatures.

2. Molding Using Food Materials and Seasonings

Second, whether or not it was possible to achieve molding in a case in which seasonings were added to dry powder of food materials was studied. As methods of adding the seasonings, one of a method of boiling food materials with seasonings before drying (Experimental Examples 69 to 77) and a method of adding seasonings to dry powder of the food materials and mixing them (Experimental Examples 78 to 82) was employed. Experimental conditions of each experimental example were summarized in Table 2, which will be described later.

### Experimental Example 69

Hot water was boiled in a pot, finely chopped commercially available oranges were put into the pot along with commercially available sugar, and the mixture was boiled for about 30 minutes. Next, the water was drained with a strainer, and the resulting product was dried by a vegetable dryer and a vacuum dryer in a manner similarly to that in Experimental Example 1, thereby obtaining dry powder. Thereafter, the dry powder was thermo-compressed using a thermo-compression molding machine under conditions of a molding temperature of 100° C., a molding pressure of 50 MPa, a molding time of 10 minutes, and water content of 0% in a manner similar to that in Experimental Example 1. However, the powder was melted and flowed out of the clearance of the mold frame, and the molding was failed, under these conditions.

### Experimental Example 70

A molded body made from oranges boiled with sugar was obtained in a manner similar to that in Experimental Example 69, except that the molding temperature was set to 60° C.

### Experimental Example 71

A molded body made from oranges boiled with sugar was obtained in a manner similar to that in Experimental Example 69, except that the molding temperature was set to 100° C. and the molding pressure was set to 6 MPa.

### Experimental Example 72

Formation of a molded body was attempted under conditions of a molding temperature of 100° C., a molding pressure of 50 MPa, a molding time of 10 minutes, and water content of 0% in a manner similar to that in Experimental Example 69, except that an inedible portion of pumpkins was boiled with commercially available consomme powder instead of boiling an inedible portion of oranges with sugar. However, the powder was melted and flowed out of the clearance of the mold frame, and the molding was failed, under these conditions.

### Experimental Example 73

A molded body made from pumpkins boiled with consomme powder was obtained in a manner similar to that in Experimental Example 72, except that the molding temperature was set to 60° C., the molding pressure was set to 30 MPa, and the molding time was set to 5 minutes.

### Experimental Example 74

A molded body made from pumpkins boiled with consomme powder was obtained in a manner similar to that in Experimental Example 72, except that the molding temperature was set to 60° C. and the molding time was set to 5 minutes.

### Experimental Example 75

A molded body made from pumpkins boiled with consomme powder was obtained in a manner similar to that in Experimental Example 72, except that the molding temperature was set to 60° C.

### Experimental Example 76

A molded body made from bananas boiled with sugar was obtained under conditions of a molding temperature of 100° C., a molding pressure of 50 MPa, a molding time of 10 minutes, and water content of 0% in a manner similar to that in Experimental Example 69, except that an inedible portion of bananas was boiled with commercially available sugar instead of boiling an inedible portion of oranges with sugar.

### Experimental Example 77

A molded body made from bananas boiled with sugar was obtained in a manner similar to that in Experimental Example 76, except that molding pressure was set to 6 MPa.

### Experimental Example 78

A molded body made from oranges and sugar was obtained under conditions of a molding temperature of 100° C., a molding pressure of 50 MPa, a molding time of 10 minutes, and water content of 0% in a manner similar to that in Experimental Example 1, except that dry powder of oranges and commercially available sugar were mixed to achieve a weight ratio of 3:1 before thermo-compression of the dry powder of oranges was carried out.

### Experimental Example 79

A molded body made from oranges and salt was obtained in a manner similar to that in Experimental Example 78, except that commercially available salt was used instead of sugar.

### Experimental Example 80

A molded body made from onions and consomme powder was obtained in a manner similar to that in Experimental Example 78, except that onions were used instead of oranges and commercially available consomme powder was used instead of sugar.

### Experimental Example 81

A molded body made from Chinese cabbages and consomme powder was obtained in a manner similar to that in Experimental Example 78, except that Chinese cabbages were used instead of oranges, commercially available consomme powder was used instead of sugar, and the molding temperature was set to 80° C.

### Experimental Example 82

A molded body made from dry powder of sea lettuces and consomme powder was obtained by thermo-compressing the dry powder using a thermo-compression molding machine in a manner similar to that in Experimental Example 51, except that the dry powder of sea lettuces and commercially available consomme powder were mixed to achieve a weight ratio of 3:1 before thermo-compressing the dry powder of sea lettuces and the molding temperature was set to 120° C.

As described above, it was confirmed that molded bodies containing seasonings were able to be obtained from at least oranges, pumpkins, bananas, onions, Chinese cabbages, and sea lettuce by boiling them with the seasonings or mixing them with the seasonings in the dry powder state.

3. Molding Using Food Materials and Edible Clay

Third, whether or not it was possible to achieve molding in a case in which edible clays were added to dry powder of food materials was studied. This study was carried out in regard to cabbages (Experimental Examples 83 to 85) and bananas (Experimental Examples 86 to 88). Experimental conditions of each experimental example were summarized in Table 3, which will be described later.

### Experimental Example 83

A molded body made from cabbages and an edible clay was obtained under conditions of a molding temperature of 100° C., a molding pressure of 50 MPa, a molding time of 10 minutes, and water content of 0% in a manner similar to that in Experimental Example 1, except that commercially available cabbages were used instead of oranges, and cabbage-derived dry powder and commercially available edible clay (GRAY Pressed natural edible clay manufactured by UCLAY) were mixed before thermo-compression of the cabbage-derived dry powder was performed to achieve a weight ratio of 3:1, and the molding temperature was set to 80° C.

### Experimental Example 84

A molded body made from cabbages and an edible clay was obtained in a manner similar to that in Experimental Example 83, except that cabbage-derived dry powder and the edible clay were mixed to achieve a weight ratio of 2:1.

### Experimental Example 85

A molded body made from cabbages and an edible clay was obtained in a manner similar to that in Experimental Example 83, except that cabbage-derived dry powder and the edible clay were mixed to achieve a weight ratio of 1:1.

### Experimental Example 86

An attempt was made to form a molded body using banana and edible clay (mixed at a weight ratio of 3:1) as raw materials in the same manner as in Experimental Example 83, except that a commercially available bananas were used instead of the cabbages.

### Experimental Example 87

A molded body made from bananas and an edible clay was obtained in a manner similar to that in Experimental Example 86, except that banana-derived dry powder and the edible clay were mixed to achieve a weight ratio of 2:1.

### Experimental Example 88

A molded body made from bananas and an edible clay was obtained in a manner similar to that in Experimental Example 86, except that banana-derived dry powder and the edible clay were mixed to achieve a weight ratio of 1:1.

As described above, it was confirmed that molded bodies containing edible clays were able to be obtained from at least cabbages and bananas.

4. Molding Using Food Materials and Plastic Powder

Fourth, whether or not it was possible to achieve molding in a case in which plastic powder was added to dry powder of food materials was studied. This study was carried out in regard to iyokan oranges. Experimental conditions of each experimental example were summarized in Table 4, which will be described later.

### Experimental Example 89

A molded body made from iyokan oranges and plastic powder was obtained under conditions of a molding temperature of 100° C., a molding pressure of 50 MPa, a molding time of 10 minutes, and water content of 0% in a manner similar to that in Experimental Example 35, except that iyokan orange-derived dry powder and commercially available polyethylene fine powder (N2000640 manufactured by Featherfield) were mixed to achieve a weight ratio of 3:1 before thermo-compression of the iyokan orange-derived dry powder was carried out.

### Experimental Example 90

A molded body made from iyokan oranges and plastic powder was obtained in a manner similar to that in Experimental Example 89, except that iyokan orange-derived dry powder and polyethylene powder were mixed to achieve a weight ratio of 2:1.

### Experimental Example 91

A molded body made from iyokan oranges and plastic powder was obtained in a manner similar to that in Experimental Example 89, except that iyokan orange-derived dry powder and polyethylene powder were mixed to achieve a weight ratio of 1:1.

As described above, it was confirmed that molded bodies containing plastic powder were able to be obtained from at least iyokan oranges.

5. Remolding

Fifth, reusability of once produced molded bodies was studied. This study was carried out in regard to cabbages (Experimental Example 92), Chinese cabbages (Experimental Example 93), and sea lettuces (Experimental Examples 94 and 95). Experimental conditions of each experimental example were summarized in Table 5, which will be described later.

### Experimental Example 92

After the cabbage-derived molded body produced in Experimental Example 13 was crushed by a disc mill, and thermo-compression molding was carried out again under conditions of a molding temperature of 80° C., a molding pressure of 6 MPa, a molding time of 10 minutes, and water content of 0%, thereby obtaining a molded body made from cabbages.

### Experimental Example 93

After the Chinese cabbage-derived molded body produced in Experimental Example 18 was crushed by a disc mill, and thermo-compression molding was carried out again under conditions of a molding temperature of 100° C., a molding pressure of 10 MPa, a molding time of 10 minutes, and water content of 0%, thereby obtaining a molded body made from Chinese cabbages.

### Experimental Example 94

After the sea lettuce-derived molded body produced in Experimental Example 52 was crushed by a disc mill, and thermo-compression molding was carried out again under conditions of a molding temperature of 120° C., a molding pressure of 10 MPa, a molding time of 10 minutes, and water content of 0%, thereby obtaining a molded body made from sea lettuces.

### Experimental Example 95

After the sea lettuce-derived molded body produced in Experimental Example 52 was crushed by a disc mill, and thermo-compression molding was carried out again under conditions of a molding temperature of 140° C., a molding pressure of 10 MPa, a molding time of 10 minutes, and water content of 0%, thereby obtaining a molded body made from sea lettuces.

As described above, it was confirmed molded bodies produced once were able to be crushed and then remolded from at least cabbages, Chinese cabbages, and sea lettuce.

6. Drying Using Oven

### Experimental Example 96

A molded body made from oranges was obtained in a manner similar to that in Experimental Example 1, except that oranges primarily dried by a vegetable dryer was input to and dried by an oven set at 105° C. instead of performing the freeze dry using a vacuum dryer.

### Experimental Example 97

A molded body made from onions was obtained in a manner similar to that in Experimental Example 96, except that commercially available onions were used instead of oranges.

### Experimental Example 98

A molded body made from bananas was obtained in a manner similar to that in Experimental Example 96, except that commercially available bananas were used instead of oranges.

As described above, it was confirmed that molded bodies were able to be formed from at least oranges, onions, and bananas by performing drying using an oven instead of freeze drying.

7. Molding for Evaluating Waterproofness

### Experimental Example 99

A molded body made from iyokan oranges was obtained in a manner similar to that in Experimental Example 1, except that commercially available iyokan oranges were used instead of oranges, the molding temperature was set to 80° C., and the molding pressure was set to 20 MPa.

### Experimental Example 100

Commercially available green tea powder (product name: green tea powder, manufactured by Honjien) was prepared, and the dry powder was thermo-compressed using a thermo-compression molding machine under conditions of a molding temperature of 80° C., a molding pressure of 20 MPa, a molding time of 10 minutes, and water content of 0%, thereby obtaining a molded body made from green tea.

### Experimental Example 101

A molded body made from iyokan oranges and green tea was obtained in a manner similar to that in Experimental Example 99, except that commercially available iyokan oranges and green tea powder were used instead of oranges, thermo-compression molding of dry powder mixed to achieve a weight ratio of 1:1 between the inedible portion of the iyokan oranges and the green tea powder was carried out, the molding temperature was set to 80° C., and the molding pressure was set to 20 MPa.

### Evaluation Example 1: Bending Strength

A three-point bending test was carried out on the molded body produced in each experimental example, and bending strength of each molded body was obtained. The three-point bending test was carried out as follows. A compression tester having a relative indication error of 2.0% or less is used. The compression tester was provided with the two metallic support rods having a diameter of about 10 mm, and a metallic pressurization rod with a diameter of 10 mm. The molded body was supported by two support rods. A load was applied to the center of the molded body at a rate of 1±0.2 N/mm² per second. The maximum load as of the timing when the molded body was broken, and the thickness at a location where the fracture surface of the broken specimen was considered to be the thinnest, were measured (see JIS A 1509-4:2014 as well). Table 1 shows the raw materials, molding conditions, whether or not the molding has successfully been performed, and bending strength of each of the molded bodies in Experimental Examples 1 to 68.

TABLE 1A

| | | | | | Water | | Bending |
|---|---|---|---|---|---|---|---|
| Experimental | Raw | Temperature/ | Pressure/ | Time/ | content/ | | strength/ |
| Example | material | ° C. | MPa | minutes | % | Success/failure | MPa |
| 1 | Oranges | 100 | 50 | 10 | 0 | Success | 10.28 |
| 2 | Green | 100 | 50 | 10 | 5 | Success | 3.04 |
| | soybeans | | | | | | |
| 3 | Pumpkins | 20 | 50 | 10 | 0 | Collapsed | |
| 4 | Pumpkins | 60 | 50 | 10 | 0 | Collapsed | |
| 5 | Pumpkins | 80 | 50 | 10 | 0 | Success | 1.63 |
| 6 | Pumpkins | 100 | 50 | 10 | 0 | Success | 2.86 |
| 7 | Pumpkins | 120 | 50 | 10 | 0 | Success | 3.71 |
| 8 | Pumpkins | 140 | 50 | 10 | 0 | Success | 4.58 |
| 9 | Pumpkins | 160 | 50 | 10 | 0 | Success | 5.81 |
| 10 | Pumpkins | 180 | 6 | 10 | 0 | Success | 6.85 |
| 11 | Pumpkins | 180 | 50 | 10 | 0 | Success | 5.58 |
| 12 | Cabbages | 60 | 50 | 10 | 0 | Success | 5.86 |
| 13 | Cabbages | 80 | 50 | 10 | 0 | Success | 9.47 |
| 14 | Cabbages | 100 | 50 | 10 | 0 | Flowed out | |
| 15 | Cabbages | 100 | 50 | 10 | 5 | Flowed out | |
| 16 | Cabbages | 100 | 50 | 10 | 10 | Flowed out | |
| 17 | Onions | 100 | 50 | 10 | 0 | Success | 8.83 |
| 18 | Chinese | 80 | 50 | 10 | 0 | Success | 16.52 |
| | cabbages | | | | | | |
| 19 | Chinese | 100 | 50 | 10 | 0 | Success | 17.73 |
| | cabbages | | | | | | |
| 20 | Bananas | 80 | 4 | 10 | 0 | Success | 6.19 |
| 21 | Bananas | 80 | 10 | 10 | 0 | Success | 10.17 |
| 22 | Bananas | 80 | 20 | 10 | 0 | Success | 9.13 |
| 23 | Bananas | 80 | 30 | 10 | 0 | Success | 8.34 |
| 24 | Bananas | 80 | 40 | 10 | 0 | Success | 5.39 |
| 25 | Bananas | 80 | 50 | 10 | 0 | Success | 5.29 |
| 26 | Bananas | 100 | 50 | 10 | 0 | Success | 9.67 |
| 27 | Bananas | 120 | 50 | 10 | 0 | Flowed out | |
| 28 | Broccoli | 60 | 50 | 10 | 0 | Success | 11.26 |
| 29 | Broccoli | 80 | 50 | 10 | 0 | Success | 8.11 |
| 30 | Broccoli | 100 | 50 | 10 | 0 | Flowed out | |
| 31 | Maitake | 60 | 50 | 10 | 0 | Collapsed | |
| | mushrooms | | | | | | |
| 32 | Maitake | 80 | 50 | 10 | 0 | Success | 3.40 |
| | mushrooms | | | | | | |
| 33 | Maitake | 100 | 50 | 10 | 0 | Success | 7.14 |
| | mushrooms | | | | | | |
| 34 | Maitake | 120 | 50 | 10 | 0 | Success | 8.57 |
| | mushrooms | | | | | | |

TABLE 1B

| | | | | | Water | | Bending |
|---|---|---|---|---|---|---|---|
| Experimental | Raw | Temperature/ | Pressure/ | Time/ | content/ | | strength/ |
| Example | material | ° C. | MPa | minutes | % | Success/failure | MPa |
| 35 | Iyokan oranges | 100 | 50 | 10 | 0 | Success | 9.34 |
| 36 | Iyokan oranges | 60 | 4 | 10 | 0 | Success | 3.48 |
| 37 | Iyokan oranges | 60 | 10 | 10 | 0 | Success | 7.15 |
| 38 | Iyokan oranges | 60 | 20 | 10 | 0 | Success | 12.00 |
| 39 | Iyokan oranges | 60 | 30 | 10 | 0 | Success | 12.44 |
| 40 | Iyokan oranges | 60 | 40 | 10 | 0 | Success | 12.64 |
| 41 | Iyokan oranges | 60 | 50 | 10 | 0 | Success | 9.95 |
| 42 | Iyokan oranges | 60 | 20 | 5 | 0 | Success | 5.12 |
| 43 | Iyokan oranges | 60 | 20 | 15 | 0 | Success | 11.71 |
| 44 | Iyokan oranges | 60 | 20 | 20 | 0 | Success | 10.79 |
| 45 | Iyokan oranges | 60 | 20 | 25 | 0 | Success | 12.18 |
| 46 | Iyokan oranges | 60 | 20 | 30 | 0 | Success | 8.20 |
| 47 | Iyokan oranges | 60 | 20 | 10 | 5 | Success | 7.98 |
| 48 | Coffee beans | 180 | 50 | 10 | 0 | Success | 3.53 |
| 49 | Coffee beans | 180 | 50 | 10 | 5 | Success | 3.67 |
| 50 | Coffee beans | 200 | 50 | 10 | 5 | Success | 6.84 |
| 51 | Sea lettuces | 100 | 50 | 10 | 0 | Collapsed | |
| 52 | Sea lettuces | 20 | 50 | 10 | 0 | Collapsed | |
| 53 | Sea lettuces | 60 | 50 | 10 | 0 | Collapsed | |
| 54 | Sea lettuces | 80 | 50 | 10 | 0 | Collapsed | |
| 55 | Sea lettuces | 120 | 50 | 10 | 0 | Success | 8.29 |
| 56 | Sea lettuces | 140 | 50 | 10 | 0 | Success | 11.90 |
| 57 | Sea lettuces | 160 | 50 | 10 | 0 | Success | 15.75 |
| 58 | Sea lettuces | 180 | 6 | 10 | 0 | Success | 6.59 |
| 59 | Sea lettuces | 180 | 50 | 10 | 0 | Success | 15.14 |
| 60 | Strawberries | 100 | 50 | 10 | 0 | Success | 5.00 |
| 61 | Crab shells | 60 | 50 | 10 | 0 | Success | 2.24 |
| 62 | Crab shells | 80 | 50 | 10 | 0 | Success | 3.64 |
| 63 | Crab shells | 100 | 50 | 10 | 0 | Success | 4.27 |
| 64 | Crab shells | 120 | 50 | 10 | 0 | Success | 2.96 |
| 65 | Crab shells | 140 | 50 | 10 | 0 | Flowed out | |
| 66 | Spinaches | 100 | 50 | 10 | 0 | Success | 4.52 |
| 67 | Purple potatoes | 100 | 50 | 10 | 0 | Success | 4.55 |
| 68 | Pumpkins + | 100 | 50 | 10 | 0 | Success | 9.37 |
| | Chinese | | | | | | |
| | cabbages (3:10) | | | | | | |

Bending Strength for Each Material

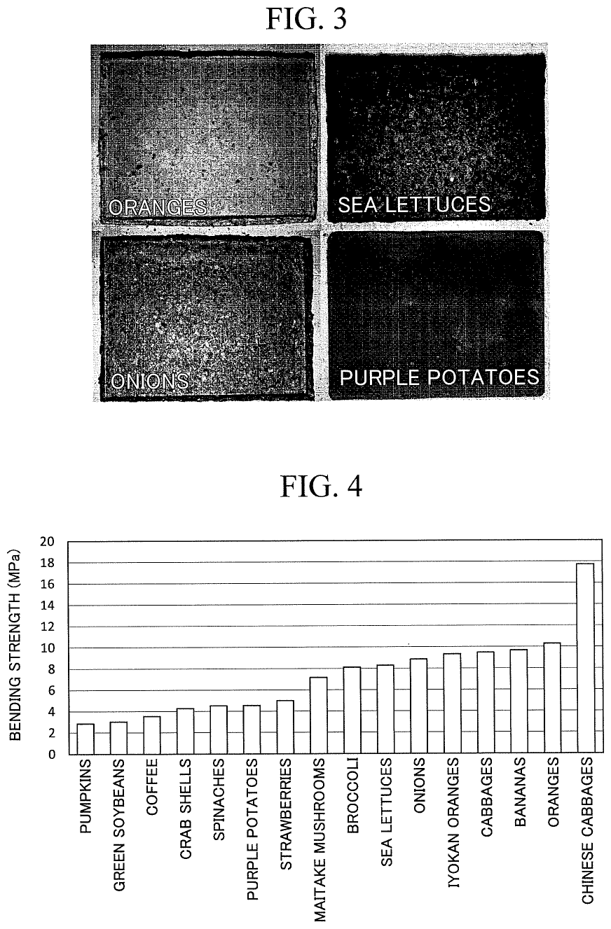

FIG. 4 shows results of comparing the bending strength of the molded bodies obtained under basic conditions (a molding temperature of 100° C., a molding pressure of 50 MPa, a molding time of 10 minutes, and water content of 0%) for each of various raw materials. However, for some of the raw materials such as those that failed to be molded under the basic conditions, results of performing molding under different conditions close to the basic conditions are shown. Specifically, results of molding green soybeans at a water content of 5%, coffee beans at a molding temperature of 180° C., cabbages and broccoli at a molding temperature of 80° C., and sea lettuce at a molding temperature of 120° C. are shown (other conditions are the same as the basic conditions).

The bending strength of the molded bodies made from green soybeans, coffee beans, crab shells, spinaches, purple potatoes, strawberries, maitake mushrooms, broccoli, sea lettuces, onions, iyokan oranges, cabbages, bananas, oranges, and Chinese cabbages, exceeded 3 MPa, which is a reference of the bending strength of a sidewalk pavement of an interlocking block defined by JIS A 5371:2016. Particularly, the bending strength of the molded bodies made from strawberries, maitake mushrooms, broccoli, sea lettuces, onions, iyokan oranges, cabbages, bananas, oranges, and Chinese cabbages, exceeded even 5 MPa, which is a reference of bending strength of a roadway pavement of an interlocking block defined by JIS A 5371:2016. Particularly, the molded body of Chinese cabbages showed the maximum bending strength from among the materials.

Molding Temperature Dependency

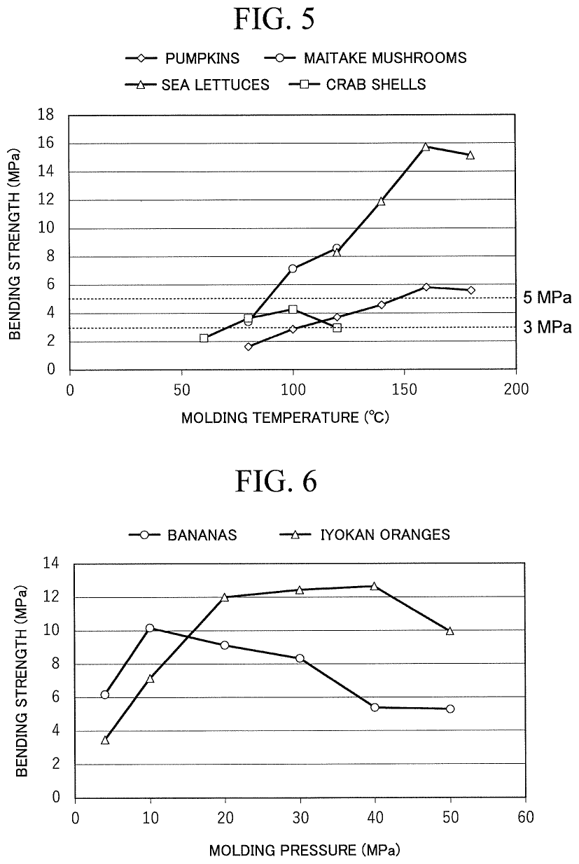

Temperature dependency of the bending strength was examined for pumpkins, maitake mushrooms, sea lettuces, and crab shells from which the molded bodies were produced at three or more molding temperatures under conditions of a molding pressure of 50 MPa, a molding time of 10 minutes, and water content of 0%. FIG. 5 shows molding temperature dependency of the bending strength of the molded bodies of pumpkins, maitake mushrooms, sea lettuces, and crab shells. Overall, a trend that the bending strength increased with an increase in temperature was observed. On the other hand, a trend that the increase width of the bending strength decreased or the bending strength decreased after the maximum point when the temperature was excessively high was also observed. It was confirmed that bending strength exceeding 3 MPa which was the bending strength of a sidewalk pavement of an interlocking block defined by JIS A 5371:2016 was obtained from all of pumpkins, maitake mushrooms, sea lettuces, and crab shells by adjusting the molding temperature and in particular, bending strength exceeding 5 MPa which was the bending strength of a roadway pavement of an interlocking block defined by JIS A 5371:2016 was obtained from pumpkins, maitake mushrooms, and sea lettuces.

Although the present invention is not intended to be limited by theory, the following mechanism is presumed, for example, as one of factors of such trends. In other words, sugar content in the heated food materials functions as an adhesive for bonding dry powder of food materials by the sugar content being melted with an increase in temperature, to maintain the shape of the thermo-compressed molded body and enhance the strength. Since sugar is not sufficiently melted if the molding temperature is excessively low, the molded body easily collapses, or sufficient bending strength cannot be obtained. On the other hand, if the molding temperature is excessively high, the function as an adhesive is not sufficiently exhibited due to combustion and charring of sugar, and the bending strength can thus decrease. As examples of the sugar, the melting point of maltose ranges from 102° C. to 108° C., the melting point of glucose containing one molecule of hydrated water is 86° C., the melting point of anhydrous crystal glucose ranges from 146° C. to 150° C., and the melting point of fructose ranges from 102° C. to 104° C.

Molding Pressure Dependency

In Experimental Examples 20 to 25 using bananas and Experimental Examples 35 to 41 using iyokan oranges, the pressure dependency of molding was studied by performing molding at molding pressures of 4 MPa, 10 MPa, 20 MPa, 30 MPa, 40 MPa, and 50 MPa. As a result, molded bodies were obtained at all the molding pressures from both bananas and iyokan oranges. FIG. 6 shows molding pressure dependency of the bending strength of the molded bodies of bananas and iyokan oranges. The maximum bending strength was obtained at a molding pressure of 10 MPa from bananas, and the maximum bending strength was obtained at a molding pressure of 40 MPa from iyokan oranges. Also, it was confirmed that bending strength exceeding 3 MPa which was a reference of the bending strength of a sidewalk pavement of an interlocking block defined by JIS A 5371:2016 was obtained at all the molding pressures and bending strength exceeding 5 MPa which was a reference of the bending strength of a roadway pavement of an interlocking block defined by JIS A 5371:2016 was obtained at all the molding pressures that were equal to or greater than 10 MPa.

Molding Time Dependency

In Experimental Examples 38 and 42 to 46 using iyokan oranges, time dependency of molding was studied by performing molding for molding times of 5 minutes, 10 minutes, 15 minutes, 20 minutes, 25 minutes, and 30 minutes. As a result, molded bodies were obtained for all the molding times. The maximum bending strength was obtained for the molding time of 25 minutes.

Water Content Dependency

In Experimental Examples 38 and 47 using iyokan oranges, water content dependency of molding was studied by performing molding at water content of 0% and 5%. As a result, molded bodies were obtained in all the examples, and the bending strength was greater in the case of the water content of 0%.

Molding Using Plurality of Materials

In Experimental Example 68 in which pumpkins and Chinese cabbages were mixed, it was confirmed that the bending strength of the molded body was improved (9.37 MPa) as compared with a case in which only pumpkins were used, by replacing a part of pumpkins (2.86 MPa) that showed the lowest bending strength with Chinese cabbages (17.73 MPa) that shoed the highest bending strength in FIG. 4.

Molding Using Food Materials and Seasonings

Table 2 shows the raw materials, molding conditions, whether or not the molding has successfully been performed, and bending strength of each of the molded bodies in Experimental Examples 69 to 82. In Experimental Examples 69 to 77 in which raw materials and seasonings were boiled from among Experimental Examples 69 to 82 in which mixing with the seasonings was performed, different results from those in a case in which only raw materials were used were obtained in terms of whether or not it was possible to achieve molding and bending strength. On the other hand, in all of Experimental Examples 78 to 82 in which mixing with seasonings was performed immediately before thermo-compression, bending strength was enhanced as compared with the case in which no seasonings were added.

TABLE 2

| | | | | | Water | | Bending |
|---|---|---|---|---|---|---|---|
| Experimental | Raw | Temperature/ | Pressure/ | Time/ | content/ | | strength/ |
| Example | material | ° C. | MPa | minutes | % | Success/failure | MPa |
| 69 | Oranges + sugar | 100 | 50 | 10 | 0 | Failure | |
| | (boiled) | | | | | | |
| 70 | Oranges + sugar | 60 | 50 | 10 | 0 | Success | 2.61 |
| | (boiled) | | | | | | |
| 71 | Oranges + sugar | 100 | 6 | 10 | 0 | Success | 3.19 |
| | (boiled) | | | | | | |
| 72 | Pumpkins + | 100 | 50 | 10 | 0 | Failure | |
| | consomme | | | | | | |
| | (boiled) | | | | | | |
| 73 | Pumpkins + | 60 | 30 | 5 | 0 | Success | 3.07 |
| | consomme | | | | | | |
| | (boiled) | | | | | | |
| 74 | Pumpkins + | 60 | 50 | 5 | 0 | Success | 6.72 |
| | consomme | | | | | | |
| | (boiled) | | | | | | |
| 75 | Pumpkins + | 60 | 50 | 10 | 0 | Success | 5.83 |
| | consomme | | | | | | |
| | (boiled) | | | | | | |
| 76 | Bananas + sugar | 100 | 50 | 10 | 0 | Success | 1.55 |
| | (boiled) | | | | | | |
| 77 | Bananas + sugar | 100 | 6 | 10 | 0 | Success | 3.22 |
| | (boiled) | | | | | | |
| 78 | Oranges + sugar | 100 | 50 | 10 | 0 | Success | 10.46 |
| | (mixed at 3:1) | | | | | | |
| 79 | Oranges + salt | 100 | 50 | 10 | 0 | Success | 11.77 |
| | (mixed at 3:1) | | | | | | |
| 80 | Onions + | 100 | 50 | 10 | 0 | Success | 9.32 |
| | consomme | | | | | | |
| | (mixed at 3:1) | | | | | | |
| 81 | Chinese | 80 | 50 | 10 | 0 | Success | 14.37 |
| | cabbages + | | | | | | |
| | consomme | | | | | | |
| | (mixed at 3:1) | | | | | | |
| 82 | Sea lettuces + | 120 | 50 | 10 | 0 | Success | 12.47 |
| | consomme | | | | | | |
| | (mixed at 3:1) | | | | | | |

Molding Using Food Materials and Edible Clays

Table 3 shows the raw materials, molding conditions, whether or not the molding has successfully been performed, and bending strength of each of the molded bodies in Experimental Examples 83 to 88. The bending strength of the molded bodies of cabbages mixed with the edible clays (Experimental Examples 83 to 85) was greater than the bending strength (9.47 MPa) in Experimental Example 13 in which no edible clay was added, at least within a weight ratio range of 3:1 to 2:1 between the raw materials and the edible clays. Also, the bending strength of the molded bodies of bananas mixed with the edible clays (Experimental Examples 86 to 88) was greater than the bending strength (9.67 MPa) in Experimental Example 27 in which no edible clay was added, at least within a weight ratio range of 3:1 to 2:1 between the raw materials and the edible clays.

TABLE 3

| | | | | | Water | | Bending |
|---|---|---|---|---|---|---|---|
| Experimental | Raw | Temperature/ | Pressure/ | Time/ | content/ | | strength/ |
| Example | material | ° C. | MPa | minutes | % | Success/failure | MPa |
| 83 | Cabbages + | 80 | 50 | 10 | 0 | Success | 12.10 |
| | edible clay | | | | | | |
| | (mixed at 3:1) | | | | | | |
| 84 | Cabbages + | 80 | 50 | 10 | 0 | Success | 10.16 |
| | edible clay | | | | | | |
| | (mixed at 2:1) | | | | | | |
| 85 | Cabbages + | 80 | 50 | 10 | 0 | Success | 8.01 |
| | edible clay | | | | | | |
| | (mixed at 1:1) | | | | | | |
| 86 | Bananas + | 100 | 50 | 10 | 0 | Success | 12.14 |
| | edible clay | | | | | | |
| | (mixed at 3:1) | | | | | | |
| 87 | Bananas + | 100 | 50 | 10 | 0 | Success | 10.28 |
| | edible clay | | | | | | |
| | (mixed at 2:1) | | | | | | |
| 88 | Bananas + | 100 | 50 | 10 | 0 | Success | 9.40 |
| | edible clay | | | | | | |
| | (mixed at 1:1) | | | | | | |

Molding Using Food Materials and Plastic Powder

Table 4 shows the raw materials, molding conditions, whether or not the molding has successfully been performed, and bending strength of each of the molded bodies in Experimental Examples 89 to 91. The bending strength in all of Experimental Examples 89 to 91 in which mixing with the plastic powder was performed was greater than the bending strength (9.34 MPa) in Experimental Example 35 in which only iyokan oranges were contained as a raw material.

TABLE 4

| | | | | | Water | | Bending |
|---|---|---|---|---|---|---|---|
| Experimental | Raw | Temperature/ | Pressure/ | Time/ | content/ | | strength/ |
| Example | material | ° C. | MPa | minutes | % | Success/failure | MPa |
| 89 | Iyokan oranges + | 100 | 50 | 10 | 0 | Success | 10.36 |
| | polyethylene powder | | | | | | |
| | (mixed at 3:1) | | | | | | |
| 90 | Iyokan oranges + | 100 | 50 | 10 | 0 | Success | 9.97 |
| | polyethylene powder | | | | | | |
| | (mixed at 2:1) | | | | | | |
| 91 | Iyokan oranges + | 100 | 50 | 10 | 0 | Success | 12.70 |
| | polyethylene powder | | | | | | |
| | (mixed at 1:1) | | | | | | |

Remolding

Table 5 shows the raw materials, molding conditions, whether or not the molding has successfully been performed, and bending strength of each of the molded bodies in Experimental Examples 92 to 95. Although the bending strength decreased as compared with those of original molded bodies in all of Experimental Examples 92 to 95 in which remolding of the molded bodies was attempted, bending strength that was higher than that in Experimental Example 94 was obtained in Experimental Example 95 in which the molding temperature at the time of the remolding was high, at least in regard to sea lettuces (Experimental Examples 94 and 95).

TABLE 5

| | | | | | Water | | Bending |
|---|---|---|---|---|---|---|---|
| Experimental | Raw | Temperature/ | Pressure/ | Time/ | content/ | | strength/ |
| Example | material | ° C. | MPa | minutes | % | Success/failure | MPa |
| 92 | Cabbages | 180 | 6 | 10 | 0 | Success | 8.76 |
| 93 | Chinese | 100 | 10 | 10 | 0 | Success | 12.51 |
| | cabbages | | | | | | |
| 94 | Sea lettuces | 120 | 10 | 10 | 0 | Success | 2.61 |
| 95 | Sea lettuces | 140 | 10 | 10 | 0 | Success | 7.31 |

### Evaluation Example 2: Appearance and Edibility

The obtained molded bodies were visually observed, and surface colors and patterns, comparison with raw states, and the like were examined. Also, the molded bodies were finely crushed and tasted, and the taste, melting feeling in the mouth, and aroma were evaluated.

First, freeze-drying and oven-drying were compared for oranges, onions, and bananas. In the molded bodies in the experimental examples of the oven-drying, the charring was conspicuous, and the appearances became dark. As for the taste, charring was felt, and bitter taste was felt as a whole. As for the aroma, the original aroma of oranges was kept, onions had stir-fried onion-like aroma, and bananas had a changed moist scent that was different from the original aroma. Charring aroma was not strongly felt in all the cases.

On the other hand, the molded bodies in the experimental examples in which drying was performed using a vacuum dryer, changes in color tones from those before drying were small, the colors were clear as compared with those achieved by oven-drying, and excellent decorative properties were achieved. As for the tastes, small changes were observed from before the drying. As for the aroma, food material aroma was felt from oranges, onions also had aroma that was similar to that of raw onions, and bananas also had a slightly sweet aroma of the food material.

Then, influences of differences in molding temperature were examined. Although there were differences due to the food materials, a trend that the colors were changed to brown or black as the molding temperature increased was observed as a whole.

Next, appearance and edibility in the case in which seasonings were added were examined. In Experimental Examples 69 to 77 in which boiling with the seasonings was performed, the colors of the molded bodies were darker than those of the molded bodies obtained in a case in which only food materials were used, and color irregularities also partially occurred. At the time of tasting, satisfactory taste was achieved in all the cases, and there were substantially no harshness and bitterness that the raw materials had. In Experimental Examples 78 to 82 in which mixing with seasonings was performed immediately before thermo-compression, the colors of the molded bodies of each food material slightly changed from those in a case in which only food materials were used. As for taste, bitterness of peels was suppressed, and the molded bodies were relatively easily eaten in Experimental Examples 78 and 79 of oranges. In Experimental Examples 80 to 82 of onions, Chinese cabbages, and sea lettuces, consomme taste was strongly felt.

Next, appearance and edibility in a case in which edible clays were added were examined. In Experimental Examples 83 to 88, comparison in a case in which the edible clays were added at changed ratios was carried out for two kinds of food materials, namely cabbages and bananas. Although the color of cabbages was changed to gray even when the clay addition ratios were low, the green color of the cabbages was slightly left in a case in which the ratios of the clays were low. The color of bananas was gradually changed to light gray as the clay addition ratios increased. In all the experimental examples, the changes in taste due to the addition of the clays were small while the texture became closer to the texture of the clays. As for the aroma, a trend that the aroma of the food materials was further suppressed as the ratios of the clays increased.

### Evaluation Example 3: Durability

For each of oranges, oranges with sugar added thereto, sea lettuces, Chinese cabbages, and maitake mushrooms, one of molded bodies split into two parts in the bending test was left on a dish at a room temperature of 22° C. for about 1 month, and the other was stored in a sealed container. One month later, changes in colors and odors, and presence/absence of occurrence of corrosion, mold, and insects were checked, and differences due to presence/absence of contact with external air were examined.

In a case in which the molded bodies using oranges were left on the dishes, the colors faded as compared with those in the sealed state. In the case in which the molded bodies were left on the dishes, there were substantially no aromas from all of the molded bodies. Even in the case in which the molded bodies were left on the dishes, there was no adhesion of contamination and insects to the surfaces. There were no big differences in tactile sensations as well.

### Evaluation Example 4: Waterproofness (Hygroscopicity)

For the molded bodies of iyokan oranges with polyethylene powder added thereto (Experimental Examples 89 to 91), the obtained molded bodies were dipped into water for 24 hours, and how much the weights increased before and after the dipping was measured to evaluate waterproofness. The evaluation was made on the assumption that the molded bodies had higher hygroscopicity and had inferior waterproofness as the weights increasing before and after the dipping in water increased.

Table 6 shows results of evaluating waterproofness in Experimental Examples 89 to 91. The weight increase rate (%) is a value obtained by dividing the weight of each molded body increasing before and after the dipping into water by the weight of the molded body before the dipping into water. A trend that as the amount of added plastic powder increased, the weight increase rates (that is, the amount of water absorbed by the molded body) decreased and waterproofness increased was confirmed.

TABLE 6

| Experimental | | Weight increase |
|---|---|---|
| Example | Raw materials | rate/% |
| 89 | Iyokan oranges + polyethylene | 147 |
| | powder (mixed at 3:1) | |
| 90 | Iyokan oranges + polyethylene | 81 |
| | powder (mixed at 2:1) | |
| 91 | Iyokan oranges + polyethylene | 66 |
| | powder (mixed at 1:1) | |

### Evaluation Example 5: Waterproofness (Maintaining of Shape of Molded Body)

For the molded body of iyokan oranges (Experimental Example 99), the molded body of green tea (Experimental Example 100), and the molded body in which iyokan oranges and green tea were mixed (Experimental Example 101), the molded bodies were dipped into water, were extracted 1 hour later, and how much the shapes were maintained was evaluated.

Although the shapes before dipping were sufficiently maintained in all the experimental examples, influences of dipping on the shapes of the molded bodies were the smallest in the molded body of green tea (Experimental Example 100) and were the second smallest in the molded body in which iyokan oranges and green tea were mixed in the comparison of Experimental Examples 99 to 101 (Experimental Example 101). Therefore, it was confirmed that green tea had more excellent waterproofness than iyokan oranges in terms of maintaining of the shapes of the molded bodies. Additionally, it was also confirmed that waterproofness was able to be improved as compared with molded bodies formed only from materials with inferior waterproofness, by forming the molded bodies by mixing a material (green tea) with excellent waterproofness with a material (iyokan oranges) with inferior waterproofness.

Moreover, for the molded body of iyokan oranges (Experimental Example 99) and the molded body of green tea (Experimental Example 100), the molded bodies were dipped into salad oil for about 5 seconds, were then dipped into water, and were extracted 1 hour later, and how much the shapes were maintained was evaluated.

Although the shapes before the dipping were sufficiently maintained in all of the experimental examples, the shape of the molded body was maintained in the same or better level in the case in which the molded body was dipped into the salad oil before being dipped into water as compared with a case in which the molded body was not dipped into the salad oil. As a feeling of touching them with a hand, the shape of the molded body was particularly maintained as compared with the case in which it was not dipped into the salad oil. Therefore, it was confirmed that waterproofness was able to be improved in terms of maintaining of the shapes of the molded bodies, by dipping the molded bodies into oil before formation of the molded bodies.

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

1. A method of manufacturing a molded body from a waste material including at least one of food waste and seaweed, the method comprising:
preparing dry powder made from at least the waste material; and
forming a molded body by pressurizing the dry powder in a state in which the dry powder is heated to a predetermined temperature.

2. The method according to claim 1, wherein the food waste is an inedible portion of food.

3. The method according to claim 1, wherein the waste material is a part or the entirety of one or more materials selected from the group consisting of oranges, green soybeans, pumpkins, cabbages, onions, Chinese cabbages, bananas, broccoli, maitake mushrooms, iyokan oranges, coffee beans, sea lettuces, strawberries, crab shells, spinaches, and purple potatoes.

4. The method according to claim 1,
wherein the waste material contains sugar, and
wherein the predetermined temperature is a melting point or higher of the sugar in the waste material.

5. The method according to claim 1, wherein the predetermined temperature is 50° C. or higher and 200° C. or lower.

6. The method according to claim 1, wherein in the forming of the molded body, a pressure applied to the dry powder is 4 MPa or more and 50 MPa or less.

7. The method according to claim 1, wherein the preparing of the dry powder includes:
drying the waste material; and
crushing the dried waste material to prepare the dry powder.

8. The method according to claim 7, wherein the drying of the waste material includes performing freeze drying of the waste material.

9. The method according to claim 1, wherein in the forming of the molded body, the dry powder is mixed with a seasoning and thermo-compressed.

10. The method according to claim 1, wherein the preparing of the dry powder further includes mixing and boiling the waste material with a seasoning.

11. The method according to claim 1, wherein in the forming of the molded body, the dry powder is mixed with plastic powder and thermo-compressed.

12. The method according to claim 1, wherein the molded body consists of the waste material, or consists of the waste material and an edible material.

13. A thermo-compressed molded body of a waste material including at least one of food waste and seaweed, wherein three-point bending strength is 3 MPa or more.

14. The thermo-compressed molded body according to claim 13, wherein the thermo-compressed molded body consists of the waste material, or consists of the waste material and an edible material.

15. A construction material, a construction, furniture, a floor cover, a container, interior goods, a tableware, or an ornament, comprising the thermo-compressed molded body according to claim 13.
